(19) United States
(12) Patent Application Publication
(10) Pub. No.: US 2003/0204386 A1
(43) Pub. Date: Oct. 30, 2003

(54) Class-based system for circuit modeling

(76) Inventors: Glenn Colon-Bonet, Ft. Collins, CO (US); Paul Robert Thayer, Ft. Collins, CO (US); Andrew Karl Rehm, Ft. Collins, CO (US); Krzysztof Filip Dydak, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/128,712

(22) Filed: Apr. 24, 2002

(51) Int. Cl. G06F 17/50

(52) U.S. Cl. 703/14

(57) ABSTRACT

A system is disclosed in which a single tool-independent model of a circuit design is used to generate a plurality of tool-specific circuit models suitable for use with a plurality of target tools, such as Automatic Test Pattern Generation (ATPG) tools and/or equivalence tools. A plurality of circuit block class definitions provide abstract interfaces to a plurality of circuit block classes. Each circuit block class definition includes a plurality of tool-specific models of the corresponding circuit block class. The tool-independent circuit model models at least some of the blocks in the circuit design by reference to the circuit block class definitions. A circuit model processor generates a tool-specific circuit model by replacing tool-independent block models in the tool-independent circuit model with corresponding tool-specific block models suitable for use with a particular one of the target tools.

### BACKGROUND

1. Field of the Invention

The present invention relates to techniques for modeling electronic circuitry and, more specifically, to techniques for providing a single model of an electronic circuit for use with multiple circuit design and circuit testing tools.

2. Related Art

Integrated circuit (ICs) designs are becoming increasingly large and complex, typically including millions of individual circuit elements such as transistors and logic gates. It is extremely important that the designs of such circuits be thoroughly tested to ensure that the resulting circuits operate correctly. Even a small number of design errors may cause significant circuit malfunction.

A particular circuit design may be tested either by testing an actual circuit that is constructed according to the design or by testing a model of the design using a simulator. To test a circuit design using a simulator it is necessary first to create a model of the design in a form that may be processed by the simulator. Various hardware description languages (HDLs) have been developed which allow circuit designs to be described at various levels of abstraction. A description of a circuit according to an HDL (referred to herein as an “HDL model” of the circuit) may, for example, describe a particular circuit design in terms of the layout of its transistors and interconnects on an IC, or in terms of the logic gates in a digital system. Descriptions at different levels of abstraction may be used for different purposes at various stages in the design process. HDL models describe circuit designs using textual expressions employing keywords and having a syntax which varies from HDL to HDL.

The two most widely-used HDLs are Verilog and VHDL (Very High Speed Integrated Circuits (VHSIC) Hardware Description Language), both of which have been adopted as standards by the Institute of Electrical and Electronics Engineers (IEEE). VHDL became IEEE Standard 1076 in 1987, and Verilog became IEEE Standard 1364 in 1995.

Once an HDL model of a particular circuit has been developed, the HDL model may be provided to a simulator to test the circuit design. Various kinds of simulation tools exist to test circuit designs specified using HDL models. These tools include, for example, the VCS™ Verilog Simulator available from Synopsys, Inc. of Mountain View, Calif. and the NC-Verilog® simulator available from Cadence Design Systems, Inc. of San Jose, Calif.

Once the HDL model has been verified, the HDL model may be provided to an Automatic Test Pattern Generator (ATPG) to test an actual circuit that has been manufactured according to the HDL model. ATPG tools generate patterns (referred to as “test patterns”) to be applied to the inputs of the circuit in order to detect faults in the circuit. The actual outputs that result from applying such test patterns are compared to the outputs predicted by the ATPG tool. The circuit is determined to be functioning properly if the actual and predicted outputs are the same. Circuit designers sometimes include in the design particular circuitry that is specially designed to facilitate circuit testing.

ATPG tools may perform various kinds of testing on a circuit design. An ATPG tool may, for example, determine whether the simulated outputs of the circuit match the expected outputs (referred to as functional testing). An ATPG tool may also, for example, perform “stuck at” testing, in which the tool observes the behavior of nodes in the circuit to determine whether particular nodes are “stuck at” zero or one, possibly as the result of an unintended open circuit or short circuit within the design. ATPG tools may also simulate the existence of faults within the circuit design and then apply various test patterns to the circuit design to determine which pattern is best at detecting faults in the circuit design. Examples of commercially-available ATPG tools include TetraMAX® from Synopsys, Inc. of Mountain View, Calif., and FastScan™ from Mentor Graphics Corporation of Wilsonville, Oreg.

Each ATPG tool has particular strengths and weaknesses. Some ATPG tools are more well-suited for testing certain kinds of circuits than other ATPG tools. It may, therefore, be desirable to test different parts of a circuit design using different ATPG tools, particularly if the design is for a large-scale integrated circuit, such as a microprocessor. Each ATPG tool may be used to test that portion of the circuit design for which it is most well-suited.

Testing a single circuit design using multiple ATPG tools typically requires that a distinct HDL model be created for use with each ATPG tool. Although ATPG tools (such as those mentioned above) typically support HDL models defined according to the Verilog HDL, it is not typically possible to create a single Verilog HDL model of a circuit that will enable testing to be performed with sufficient accuracy by multiple ATPG tools, particularly in the case of large and complex circuits that include significant amounts of non-standard circuitry.

Different ATPG tools, for example, sometimes interpret the same Verilog code in different ways. In particular, Verilog allows certain logic gates to be defined purely in terms of the functions they perform. Although some ATPG tools simulate the correct results when provided with such logic gate definitions, some do not. Furthermore, different ATPG tools may interpret the same Verilog code for sequential logic circuits differently. As a result, it is sometimes necessary to create different HDL models of a particular circuit design for use with different ATPG tools, even if all of the HDL models are written according to a single HDL, such as Verilog.

Furthermore, equivalence tools exist for testing whether a constructed circuit is equivalent to the design from which it was constructed. Such tools also accept HDL models of the circuit to be tested. It is sometimes necessary to use a different HDL model with an equivalence tool than with ATPG tools. It would be desirable to be able to use a single HDL model in conjunction with both ATPG tools and equivalence tools.

Referring to FIG. 1, for example, a prior art system 100 is shown for testing a circuit design 102 using a plurality of target tools 108a-c. As used herein, the term “target tool” refers generically to any tool, such as an ATPG tool or an equivalence tool, which may accept an HDL model as input. The circuit design 102 may represent a design in the mind of a human circuit modeler 104 or a design expressed in a form other than an HDL, such as a schematic diagram. The human circuit modeler 104 generates tool-specific HDL models 106a-c of the circuit design 102. Each of the tool-specific HDL models is created specifically for use with a corresponding one of the target tools 108a-c.

Creating individual HDL models is tedious, time-consuming, and error-prone, and creating multiple tool-specific HDL models 106a-c as shown in FIG. 1 is particularly burdensome. Although automatic modeling tools exist which are intended to analyze an actual circuit and automatically generate a Verilog model of the circuit, such tools do not always produce perfect results, particularly in the case of circuits including non-standard circuitry. It is, therefore, typically necessary for the human circuit modeler 104 to write each of the tool-specific HDL models 106 manually.

What is needed, therefore, are techniques for enabling circuits and circuit designs to be tested using multiple testing tools without requiring the development of a distinct tool-specific circuit model for use with each tool.

### SUMMARY

A system is disclosed in which a single tool-independent model of a circuit design is used to generate a plurality of tool-specific circuit models suitable for use with a plurality of testing tools, such as Automatic Test Pattern Generation (ATPG) tools and/or equivalence tools (referred to as “target tools”). A plurality of circuit block class definitions provide abstract interfaces to a plurality of circuit block classes. Each circuit block class definition includes a plurality of tool-specific models of the corresponding circuit block class. The tool-independent circuit model models at least some of the blocks in the circuit design by reference to the circuit block class definitions, thereby modeling the circuit design using a model that is not tightly coupled to any particular one of the target tools. A circuit model processor generates a tool-specific circuit model by replacing tool-independent block models in the tool-independent circuit model with corresponding tool-specific block models suitable for use with a particular one of the target tools. The single tool-independent circuit model may thereby be used to generate a plurality of tool-specific circuit models suitable for use with a plurality of target tools.

Other features and advantages of various aspects and embodiments of the present invention will become apparent from the following description and from the claims.

### BRIEF DESCRIPTION OF THE DRAWINGS

FIG. 1 is a dataflow diagram of a prior art system for generating multiple tool-specific HDL models of a circuit design;

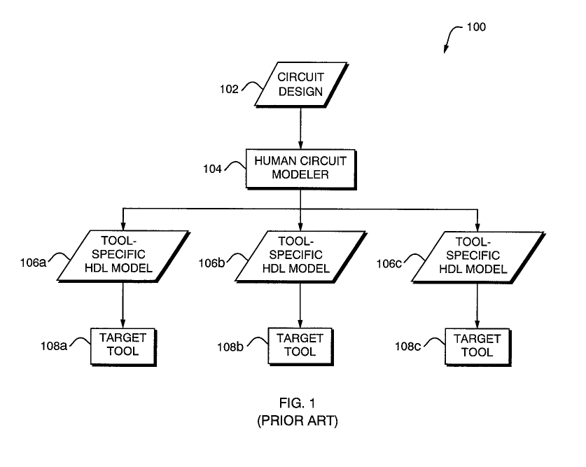

FIG. 2 is a dataflow diagram of a system for automatically generating multiple tool-specific models of a circuit design based on a tool-independent model of the circuit design according to one embodiment of the present invention;

FIG. 3 is a schematic block diagram of an example circuit design that may be modeled in accordance with various embodiments of the present invention;

FIG. 4 is a functional block diagram of a tool-independent circuit model according to one embodiment of the present invention;

FIG. 5 is a functional block diagram of the logical structure of a tool-independent circuit block model according to one embodiment of the present invention;

FIG. 6A is a functional block diagram of a plurality of circuit block class definitions according to one embodiment of the present invention;

FIG. 6B is a functional block diagram of the logical structure of a circuit block class definition according to one embodiment of the present invention;

FIG. 7 is a flowchart of a method that is used in one embodiment of the present invention to generate a tool-specific circuit model based on a tool-independent circuit model;

FIG. 8 is a functional block diagram of the contents of a plurality of tool-specific circuit models in one embodiment of the present invention;

FIG. 9 is a schematic circuit diagram of a two-input dynamic AND gate that may be modeled according to one embodiment of the present invention;

FIG. 10A is a code listing of a Verilog tool-independent circuit model that is used to model a dynamic AND gate in one embodiment of the present invention; and

FIG. 10B is a code listing of a Verilog class definition according to one embodiment of the present invention.

### DETAILED DESCRIPTION

A system is disclosed in which a single tool-independent model of a circuit design is used to generate a plurality of tool-specific circuit models suitable for use with a plurality of testing tools, such as Automatic Test Pattern Generation (ATPG) tools and/or equivalence tools (referred to as “target tools”). A plurality of circuit block class definitions provide abstract interfaces to a plurality of circuit block classes. Each circuit block class definition includes a plurality of tool-specific models of the corresponding circuit block class. The tool-independent circuit model models at least some of the blocks in the circuit design by reference to the circuit block class definitions, thereby modeling the circuit design using a model that is not tightly coupled to any particular one of the target tools. A circuit model processor generates a tool-specific circuit model by replacing tool-independent block models in the tool-independent circuit model with corresponding tool-specific block models suitable for use with a particular one of the target tools. The single tool-independent circuit model may thereby be used to generate a plurality of tool-specific circuit models suitable for use with a plurality of target tools.

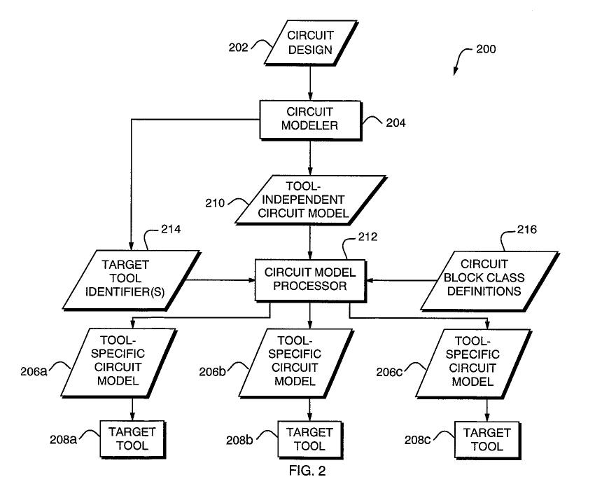

Referring to FIG. 2, a dataflow diagram is shown of a system 200 that is used in one embodiment of the present invention to provide a single tool-independent circuit model 210 of a circuit design 202 for use with a plurality of target tools 208a-c. As described in more detail below, the tool-independent circuit model 210 models the circuit design 202 at a level of abstraction that does not include details which are required only for use with a single one of the target tools 208a-c. The tool-independent circuit model 210 may, for example, not include HDL code that is designed particularly for use with one of the target tools 208a-c but not with all of the target tools 208a-c.

A circuit modeler 204 generates the tool-independent circuit model 210 of the circuit design 202. Circuit modeler 204 may, for example, be a human circuit modeler or an automated modeling tool. The circuit design 202 may represent a design in the mind of a human circuit modeler or a design expressed in an HDL or in a form other than HDL, such as a schematic diagram.

A circuit model processor 212 processes the tool-independent circuit model 210 to produce one or more tool-specific circuit models 206a-c, each of which is targeted for use with a particular one of the target tools 208a-c. The circuit modeler 204 may provide to the circuit model processor 212 one or more tool identifiers 214 identifying one or more of the target tools 208a-c. The circuit model processor 212 may generate tool-specific circuit models for only those ones of the target tools 208a-c that are identified by the tool identifier(s) 214. As described in more detail below, the circuit model processor 212 also receives as inputs a plurality of circuit block class definitions 216, which the circuit model processor 212 may use to produce tool-specific HDL code within the tool-specific circuit models 206a-c based on the tool-independent circuit model 210.

The target tools 208a-c may, for example, be circuit testing tools or circuit design testing tools such as ATPG tools and/or equivalence tools. The tools 208a-c may include, for example, the TetraMAX® and FastScan™ tools described above.

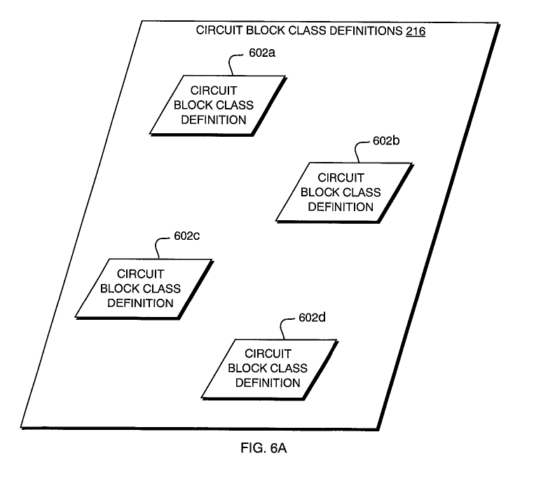

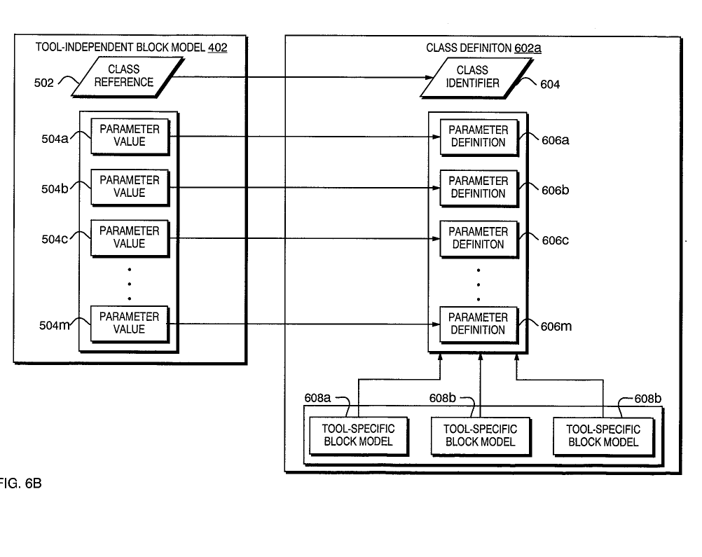

Operation of the system 200 shown in FIG. 2 will now be described in more detail. First, the class definitions 216 will be described. Referring to FIG. 6A, a functional block diagram is shown of the circuit block class definitions 216 according to one embodiment of the present invention. Although for purposes of example four circuit block class definitions 602a-d are shown, it should be appreciated that there may be any number of circuit block class definitions. The circuit block class definitions 216 are referred to alternatively herein as a circuit block class library.

Each of the class definitions 602a-d corresponds to a particular class of circuit block. Each of the class definitions 602a-d provides an abstract interface to the corresponding class of circuit block that is independent of the requirements of any one of the target tools 208a-c. The circuit modeler 204 may model some or all of the circuit design 202 using the abstract interface provided by the class definitions 216, thereby enabling the single tool-independent circuit model 210 to model the circuit design 202 using a model that is not tightly coupled to any particular one of the target tools 208a-c.

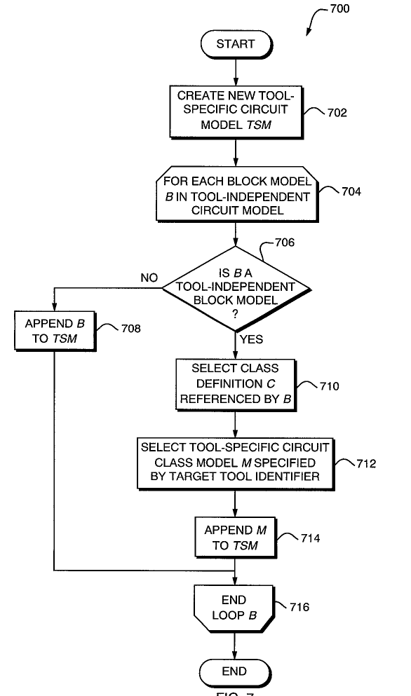

To enable the circuit model processor 212 to generate the tool-specific circuit models 208a-c based on the tool-independent circuit model 210, each of the class definitions 216 includes a plurality of tool-specific models of the corresponding block class. As described below with respect to FIG. 7, the circuit model processor 212 may generate one of the tool-specific circuit models 206a-c by inserting appropriate tool-specific block models from the class definitions into the tool-independent circuit model 210.

A particular circuit design, for example, typically includes several different classes of circuits. A simple design, for example, might include circuits that fall into one of three categories: static logic (combinational logic), flip-flops (edge-sensitive sequential logic), and latches (level sensitive sequential logic). For such a design, there might be three class definitions, one for each category of circuit. Because static logic circuits may typically be modeled in the same way (e.g., using the same HDL code) for use with a variety of target ATPG tools, the class definition for static logic circuits might be empty. Different ATPG tools, however, typically provide their own distinct models for flip-flops and latches. The class definitions for flip-flops and latches might, therefore, provide a distinct tool-specific model for each of the tools 208a-c, in which the corresponding block class is modeled using the appropriate model from the corresponding tool. For example, the class definition for a flip-flop might include a tool-specific flip-flop model targeted to the FastScan™ ATPG tool, in which the flip-flop is modeled using the D flip-flop (DFF) primitive that is built in to FastScan™. Particular examples of class definitions are provided in more detail below.

The class definitions 216 may be created by identifying one or more blocks which benefit from being modeled differently (e.g., described using different HDL code) for use with different ones of the target tools 208a-c. For each such block, a class definition is provided which provides an abstract interface to the block. This interface parametrizes the block's structure and/or function in a manner that is independent of the particular manner in which the block is to be modeled for each of the tools 208a-c. The class definition also includes a tool-specific model of the block for use with each of the target tools 208a-c. Each tool-specific block model in a class definition makes used of the parameters defined by the class in conjunction with generic and/or tool-specific primitives to provide a model of the block that will provide satisfactory results when used with the corresponding tool.

Once generated, the circuit block class definitions 216 provide a library of classes for the circuit modeler 204 to use when modeling the circuit design 202. When modeling a particular block that is a member of a class defined by the class definitions 216, the circuit modeler 204 may model the block using a tool-independent block model that references the corresponding class definition and specifies particular parameter values for parameters defined by the class definition. Particular examples of such tool-independent block models are provided in more detail below.

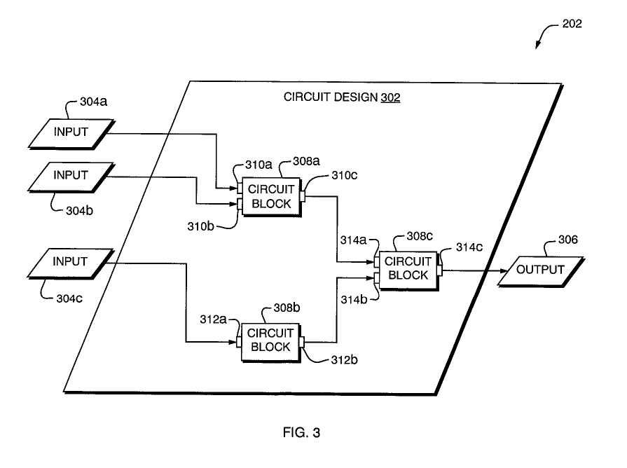

Referring to FIG. 3, a schematic block diagram is shown of an example of circuit design 202. The circuit design 202 includes a circuit 302 having input signals 304a-c and output signal 306. The circuit 302 includes sub-circuits 308a-c, referred to herein as “circuit blocks” or merely as “blocks.” Blocks 308a-c may, for example, be analog circuit components (e.g., resistors, capacitors, diodes), digital logic gates (e.g., AND gates, OR gates, XOR gates), or any other kind of circuit components. Blocks 308a-c are illustrated as abstract blocks in FIG. 3 for ease of illustration and explanation.

As should be apparent from FIG. 3, circuit block 308a receives as input the input signals 304a-b (at inputs 310a-b, respectively) and provides an output signal at output 310c. Circuit block 308b receives as input the input signal 304c (at input 312a) and provides an output signal at output 312b. Circuit block 308c receives as input the output signals provided by blocks 308a-b (at inputs 314a-b, respectively), and provides an output signal 306 at output 314c. The output signal 306 is provided as the output of the circuit 302.

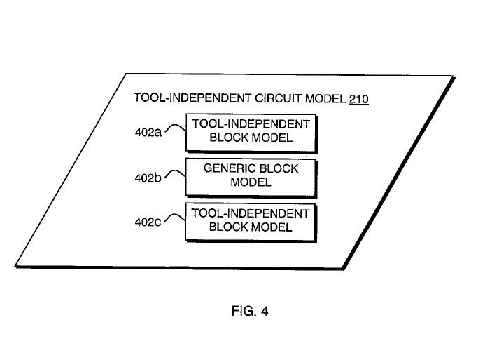

Referring to FIG. 4, the tool-independent circuit model 210 is illustrated in more detail. For purposes of example assume that the tool-independent circuit model 210 models the circuit design 202 illustrated in FIG. 3. The tool-independent circuit model 210 includes circuit block models 402a-c (also referred to herein simply as “block models,”) each of which models a corresponding one of the circuit blocks 308a-c shown in FIG. 3. The tool-independent circuit model 210 may, for example, be a single HDL file in which each of the block models 402a-c models a corresponding block using particular HDL code. Such code may model both the individual structure and/or behavior of the blocks 308a-c as well as their structural and/or functional interrelationships with each other.

In the present example, block models 402a and 402c are tool-independent block models, while block model 402b is a generic block model. As used herein, the term “generic block model” refers to a block model that is suitable for use with all of the potential target tools 208a-c. For example, as described above, in some cases it is possible to model a particular circuit block using particular HDL code that will provide satisfactory results when used in conjunction with several target tools. Such a circuit block may be modeled using what will be referred to herein as “generic HDL code,” such as a single line or small number of lines of standard Verilog code, which will provide satisfactory results when used in conjunction with all of the target tools 208a-c.

As used herein, the term “tool-independent block model” refers to a block model that is represented at a higher level of abstraction than the HDL code that is suitable for use with any one of the target tools 208a-c. HDL code that may be used in a tool-independent block model will be referred to herein as “tool-independent HDL code.” As described in more detail below, the circuit model processor 212 may replace tool-independent HDL code in the tool-independent circuit model 210 with tool-specific HDL code, thereby generating one or more tool-specific circuit models 206a-c suitable for use with the target tools 208a-c.

For example, assume that blocks 308a and 308c (FIG. 3) are members of circuit classes defined in the class definitions 216, but that block 308b is not a member of such a class. The circuit modeler 204 may, in such a case, model the blocks 308a and 308c using tool-independent block models and model the block 308b using a generic block model. Referring again to FIG. 4, in such a case the block models 402a-c may model the circuit blocks 308a-c (FIG. 3), respectively.

Whether the results provided by using particular HDL code with multiple target tools are “satisfactory” may vary depending upon the needs of the particular application. For example, if the target tools are ATPG test tools, the circumstances may require that each of the ATPG test tools that is used be capable of providing test results to a particular degree of accuracy. If highly accurate results are required, it may only be possible to model a small number of blocks in the circuit design 202 using generic HDL code, because the use of such code for many blocks (particularly highly-customized blocks) may lead to insufficiently accurate results when used in conjunction with particular test tools. As described in more detail above with respect to FIGS. 6A-6B, the designer of the circuit block class definitions 216 may provide a greater or lesser number of class definitions to make it possible to model a greater or lesser number of circuit block classes using tool-independent HDL code depending upon the needs of the particular application.

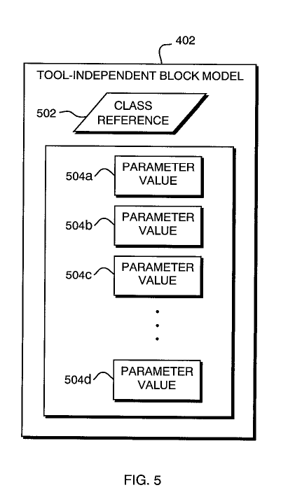

Referring to FIG. 5, a functional block diagram is shown of the logical structure of the tool-independent block model 402a according to one embodiment of the present invention. Although only tool-independent block model 402a is shown in FIG. 5, it should be appreciated that other tool-independent block models (such as tool-independent block model 402c) may have the same logical structure. The tool-independent block model 402a includes a class reference 502 which refers to a particular one of the circuit class definitions 216, thereby specifying to which class the block modeled by the tool-independent block model 402a belongs. According to the terminology of object-oriented computer programming, the tool independent block model 402a is an “instance” of the class referenced by the class reference 502.

The tool-independent block model 402a also includes a plurality of parameter values 504a-m, where m is the number of parameters. As described in more detail below with respect to FIG. 6B, the parameter values 504a-m are particular values of parameters that may vary among class instances within a particular class. Although a plurality of parameter values 504a-m are shown in FIG. 5, it should be appreciated that there may be any number of parameters, including zero or one.

Referring to FIG. 6B, a functional block diagram is shown which illustrates both the logical structure of class definition 602a and the relationship between the class definition 602a and the tool-independent block model 402 according to one embodiment of the present invention. Although not shown in FIG. 6B, the other circuit block class definitions 602b-d have the same logical structure. For purposes of example, the particular class definition 602a shown in FIG. 6B defines the circuit block class of which the circuit block (e.g., circuit block 308a in FIG. 3) modeled by the tool-independent block model 402a (FIG. 4) is an instance. The class definition 602a includes a class identifier 604 which uniquely identifies the class definition 602a among the plurality of class definitions 602a-d. The class identifier 604 may be any unique identifier, such as a unique sequence of bits or a text string. As shown in FIG. 6B, the class reference 502 of the tool-independent block model 402 references the class definition 602a by referencing the class identifier 604. If, for example, class identifier 604 is a unique number or text string, class reference 502 may contain the unique number or text string, thereby referencing class definition 602a.

The class definition 602a also includes a plurality of parameter definitions 606a-m. The parameter definitions 606a-m define parameters the values of which may vary among instances of the class. Each of the parameters values 504a-m in the tool-independent block model 402 provides a value for a parameter defined by a corresponding one of the parameter definitions 606a in the class definition 602a. As described in more detail below, the processor 212 may apply the parameter values 504a-m to the parameter definitions 606a-m when creating an instance of the class defined by class definition 602a. Each of the parameter definitions 606a-m may specify, for example, a name and data type for the corresponding parameter. Data types may include, for example, data types such as input, output, trireg, and other data types employed by HDLs such as Verilog.

The class definition 602a also includes tool-specific circuit block models 608a-c, each of which may provide tool-specific HDL code that models the class of circuits defined by the class definition 602a and which is suitable for use with a particular one of the target tools 208a-c. For example, tool-specific block model 608a may provide tool-specific HDL code that models the class of circuits of which circuit 308a (FIG. 3) is a member and which is suitable for use with target tool 208a. Tool-specific block models 608a-c are illustrated in FIG. 6B as referring to the parameter definitions 606a-m because the tool-specific block models 608a-c may be parametrized using the parameters defined by the parameter definitions 606a-m.

Referring to FIG. 7, a flowchart is shown of a method 700 that is used by the circuit model processor 212 to generate one of the tool-specific circuit models 206a-c based on the tool-independent circuit model 210, the target tool identifier 214, and the class definitions 216. Although in the process 700 shown in FIG. 7 the target tool identifier 214 identifies only a single one of the target tools 208a-c, it should be appreciated that this is merely an example and not a limitation of the present invention.

The circuit model processor 212 creates a new tool-specific circuit model, referred to below for purposes of brevity as TSM (step 702). The model TSM may, for example, be an empty HDL file. Both the tool-independent circuit model 210 and the tool-specific circuit model TSM may, for example, be expressed using the same HDL, such as Verilog. For purposes of the present example, assume that the target tool identifier 214 identifies target tool 208a.

The circuit model processor 212 executes a loop over each block model B in the tool-independent block model 210 (step 704). The circuit model processor 212 may, for example, loop over each line of HDL code in the tool-independent block model 210 sequentially.

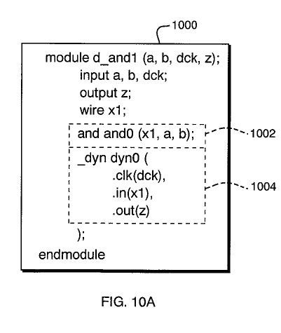

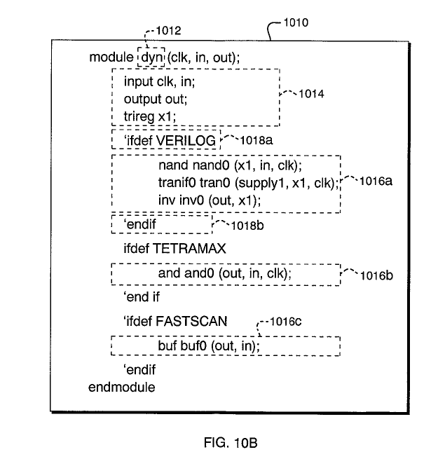

The circuit model processor 212 determines whether block model B is a tool-independent block model (step 706). An example of one way in which the circuit model processor 212 may make this determination is described in more detail below with respect to FIGS. 10A-10B.

If the block model B is not a tool-independent block model (i.e., if it is a generic block model), the circuit model processor 212 appends the block model B to model TSM (step 708). In other words, if the block model B is a generic block model, then it is suitable for use directly with any of the target tools 208a-c and may therefore be copied directly into the tool-specific circuit model TSM.

If the block model B is a tool-independent block model, then the circuit model processor 212 selects the class definition C referenced by block model B (step 710). Assume, for purposes of example, that block model B is the tool-independent block model 402a (FIG. 5), in which class reference 502 references class definition 602a. Circuit model processor 212 may examine the class reference 502 in step 710 to determine which class is referenced by the class reference 502 and then select the referenced class.

The circuit model processor 212 selects the tool-specific circuit block model M, within the selected class definition C, that is specified by the target tool identifier 214 (step 712). For example, referring again to FIG. 6B, assuming that the class definition C is class definition 602a and that the target tool identifier 214 identifies target tool 208a, the circuit model processor 212 in step 712 selects the tool-specific block model 608a, because it is the tool-specific block model within class definition C that corresponds to the target tool specified by the target tool identifier 214.

The circuit model processor 212 appends block model M to the tool-specific model TSM (step 714). In other words, the circuit model processor 212 selects the tool-specific HDL code that models the block B in a manner that is suitable for use with the identified target tool and inserts the selected tool-specific HDL code into the tool-specific circuit model being generated by the process 700. As part of step 714 the circuit model processor 212 may substitute the actual parameter values provided by the block model B (e.g., the parameter values 504a-m in FIG. 5) for the parameter definitions referenced in the tool-specific HDL block model M (e.g., the parameter definitions 606a-m).

The circuit model processor 212 repeats steps 706-714 for each block model B in the tool-independent model (step 716). Upon completion of the process 700, the tool-specific circuit model TSM includes tool-specific HDL code that models the circuit design 202 and which is suitable for use with the particular one of the target tools 208a-c identified by the target tool identifier 214. The effect of process 700 is to create a tool-specific circuit model that is the same as the tool-independent circuit model 210, except that each tool-independent block model in the tool-independent circuit model 210 is replaced with a corresponding tool-specific block model in the tool-specific circuit model.

Although the process 700 creates a new tool-specific circuit model and copies block models from the tool-independent circuit model 210 and the class definitions 216 into the tool-specific circuit model, the process 700 may be implemented in other ways which do not involve creating a new tool-specific circuit model. For example, the circuit model processor 212 may achieve the same effect as that of the process 700 by modifying the existing tool-independent circuit model 210. In such a case, step 702 would be omitted from the process 700. Furthermore, in step 708 the circuit model processor 212 would do nothing (i.e., perform a null operation), because the tool-independent circuit model 210 already includes the block model B. In addition, step 714 would be performed by replacing the existing block B in the tool-independent circuit model 210 with the tool-specific model M provided by the class definition C. The effect of performing this modified version of process 700 would be to transform the tool-independent circuit model 210 into a tool-specific circuit model suitable for use with the selected one of the target tools 208a-c.

The system 200 provides the benefits of the object-oriented programming feature of polymorphism, in which a class reference in the tool-independent circuit model 210 is resolved into a tool-specific circuit model at the time of processing by the circuit model processor 212, the particular target tool being selected by the target tool identifier 214 at the time of processing. This both allows the circuit modeler 204 to create a circuit model that is not dependent on any particular tool while allowing the circuit model to be specifically tailored to a particular one of the target tools 208a-c at the time of processing without requiring the circuit modeler 204 to modify the tool-independent circuit model 210. Additional advantages of the system 200 will be described in more detail below.

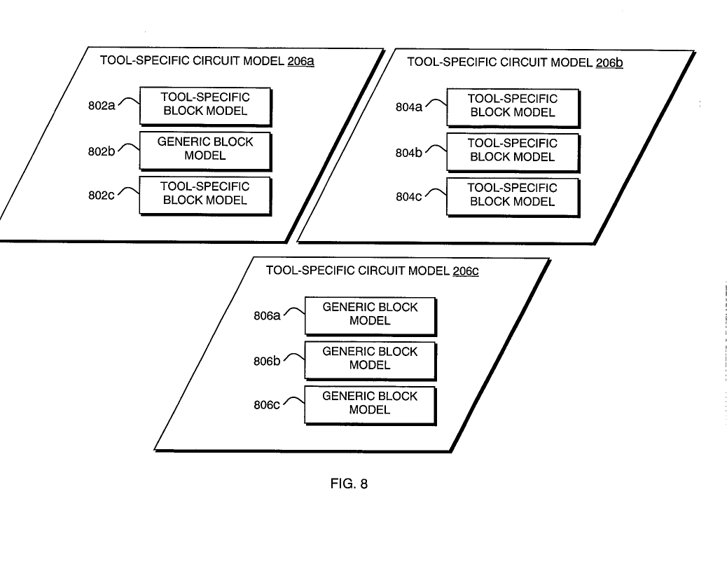

Referring to FIG. 8, examples of the contents of the tool-specific circuit models 206a-c are shown. Assume for purposes of example that tool-specific circuit model 206a models the circuit design 202 shown in FIG. 3 and was generated by processing the tool-independent circuit model 210. As shown in FIG. 8, the tool-specific circuit model 206a includes block models 802a-c, in which block models 802a and 802c are tool-specific block models (i.e., they include tool-specific HDL code), and in which block model 802b is a generic block model (i.e., it includes generic HDL code).

Referring again to FIG. 8, examples of the contents of the tool-specific circuit models 206b-c are shown. Although, as described above with respect to FIG. 7, a tool-specific circuit model may include a combination of tool-specific and tool-independent block models, this is not a limitation of the present invention. Rather, a tool-specific circuit model may, as in the case of tool-specific circuit model 206b, include only tool-specific block models (e.g., block models 804a-c), or, as in the case of tool-specific circuit model 206c, include only generic block models (e.g., block models 806a-c). The particular combination of tool-specific and generic block models that are included within a particular tool-specific circuit model will vary depending on the particular combination of tool-independent and generic block models within the corresponding tool-independent circuit model. For example, each tool-independent block model in the tool-independent circuit model 210 (FIG. 4) corresponds to a tool-specific block model in the tool-specific circuit model 206a (FIG. 8), while each generic block model in the tool-independent circuit model 210 (FIG. 4) corresponds to the same generic block model in the tool-specific circuit model 206a (FIG. 8)

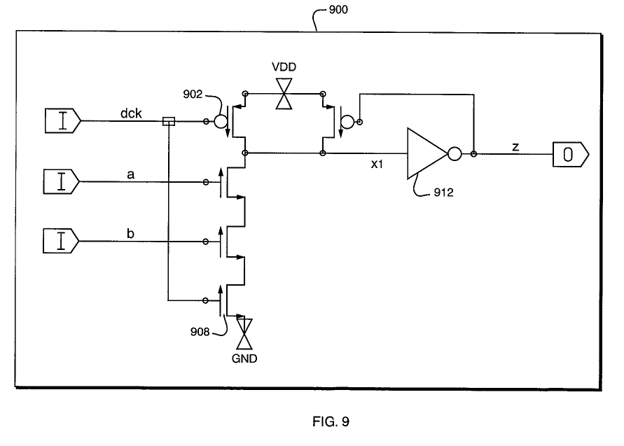

Referring to FIG. 9, a particular example will now be described in which the circuit design 202 is a design for a two-input dynamic AND gate 900. In one embodiment, the dynamic AND gate 900 is modeled using the Verilog HDL, and the three target tools 208a-c are implemented using a Verilog simulator that might be used for equivalence (such as the VCS™ Verilog Simulator or the NC-Verilog® simulator mentioned above), the FastScan™ ATPG tool, and the TetraMAX® ATPG tool, respectively.

Referring to FIG. 10A, a Verilog tool-independent circuit model 1000 is shown that is used to model the dynamic AND gate 900 in one embodiment of the present invention. The tool-independent circuit model 1000 is one example of the tool-independent circuit model 210 shown in FIG. 2. Referring to FIG. 9, the dynamic AND gate 900 has three inputs (a, b, and dck), one output (z), and a wire (xl), which are modeled in the Verilog model 1000 (FIG. 10) using variables having the same names.

The AND functionality of the dynamic AND gate 900 is captured in the tool-independent circuit model 1000 using the Verilog “and” primitive 1002, because the Verilog “and” primitive is interpreted by all of the target tools described above in a manner that provides satisfactory results. The line of HDL code 1002 containing the “and” primitive is therefore an example of a generic block model and of generic HDL code.

The dynamic nature of the dynamic AND gate 900, however, is modeled using a reference 1004 to the “_dyn” class. Referring to FIG. 10B, an example Verilog class definition 1010 of the “_dyn” class is shown. The class definition 1010 is one example of the class definitions 216 shown in FIG. 2.

The text “_dyn” 1012 on the first line of the class definition 1010 identifies the name of the class and is an example of the class identifier 604 shown in FIG. 6B. The first three lines 1014 following the class name define the class parameters and constitute an example of the parameter definitions 606a-m shown in FIG. 6B. In particular, the “_dyn” class has four parameters: two input parameters named “clk” and “in,” an output parameter named “out,” and a trireg parameter named “x1.”

The class definition 1010 also includes three tool-specific block models 1016a-c, each of which provides a Verilog model for use with a specific one of the tools 208a-c. The tool-specific block models 1016a-c are examples of the tool-specific block models 608a-c shown in FIG. 6B. In particular, the first tool-specific block model 1016a, which is designed for use with the above-referenced Verilog equivalence tool, models both clocked evaluate transistor 908 along with clocked precharge transistor 902. The storage node x1 in the dynamic AND gate 900 is modeled using the “trireg” net type. The final output inverter 912 is also modeled in the block model 1016a. Although the tool-specific block model 1016a represents the dynamic AND gate 900 very accurately, it will not work well with most ATPG tools.

The second tool-specific block model 1016b, which is designed for use with TetraMAX®, models the clocked evaluate transistor 908 by ANDing the result of the initial AND operation with the clock dck. The tool-specific block model 1016b ignores other details of the dynamic AND gate circuit 900 because these are not needed by the TetraMAX® ATPG tool.

The third tool-specific block model 1016c, which is designed for use with FastScan™, is essentially empty, because the FastScan™ ATPG tool does not make use of the clock interaction in the dynamic AND gate circuit 900. The Verilog “buf” primitive used by the model 1016c merely transfers the input “in” to the output “out.”

The pairs of lines in the class definition 1010 beginning with “′ifdef” and “′endif” are directives to the circuit model processor 212, indicating that the text contained therein defines a model targeted at a particular one of the target tools 208a. For example, the lines 1018a-b indicate that the Verilog code 1016a contained therebetween defines a model targeted at the Verilog equivalence tool referenced above. The target tool identifier 214 may identify the desired target tool using text, such as “VERILOG,” “TETRAMAX,” or “FASTSCAN,” that corresponds to one of the labels used within the class definition 1010. In one embodiment, the circuit modeler 204 provides the target tool identifier 214 by providing an additional line at or near the beginning of the tool-independent block model 1000 reading “′def VERILOG,” “′def TETRAMAX,” or “′def FASTSCAN,” depending on the particular target tool 208a he wishes to target. The circuit model processor 212 reads this line and selects the identified target tool in step 712 of the process 700 described above with respect to FIG. 7.

Although a dynamic AND gate is described above with respect to FIG. 9, it should be appreciated that the techniques disclosed herein may be employed to model any kind of electronic circuitry, as will be apparent to those of ordinary skill in the art. Kinds of circuits to which the techniques disclosed herein may be applied include, but are not limited to, clock devices (e.g., clock gaters and pulse generators), sequential devices (e.g., flip-flops and latches), and memory elements (e.g., random access memories, read only memories, and content addressable memories).

Although the present invention is described above with respect to particular embodiments, the present invention is not limited to the particular embodiments described. Rather, the present invention may be implemented according to other embodiments including, but not limited to, the following.

Any of a variety of HDLs may be used in conjunction with various embodiments of the present invention. Such HDLs include, but are not limited to Verilog and VHDL. One or more of the tool-independent circuit model 210, the target tool identifier 214, the circuit block class definitions 216, and the tool-specific circuit models 206a-c may be implemented using one or more HDLs. A single HDL, such as Verilog, may be used to implement the tool-independent circuit model 210, the tool-specific circuit models 206a-c, and the circuit block class definitions 216.

As used herein, the terms “circuit block” and “block” refer to any circuit and any component thereof, and may also refer to a particular behavior or feature of a block, such as the dynamic behavior of the dynamic AND gate described above with respect to FIG. 9. Therefore, a tool-independent or generic block model may model a specific feature or behavior of a particular sub-circuit rather than the entire sub-circuit. As a result, a particular sub-circuit may be modeled by a combination of tool-independent and generic block models.

The circuit model processor 212 may be implemented in any of a variety of ways. It may, for example, be implemented in hardware, software, firmware, or any combination thereof. The circuit model processor 212 may, for example, be implemented using a Verilog compiler, such as the VCS™ Verilog Simulator available from Synopsys, Inc. of Mountain View, Calif. or the NC-Verilog® simulator available from Cadence Design Systems, Inc. of San Jose, Calif. If such a compiler is used, the circuit block class definitions 216 may be implemented as a library of Verilog modules. Such compilers are capable of compiling Verilog models such as those shown in FIGS. 10A-10B and of interpreting the ′ifdef directives shown in FIG. 10B to import Verilog code from an appropriate Verilog module in the library into the tool-independent circuit model 210, thereby producing one of the tool-specific circuit models 206a-c, as described above with respect to FIG. 7.

Although ATPG tools and equivalence tools are described above as examples of the target tools 208a-c, it should be appreciated that the target tools 208a-c are not limited to such tools. Rather, the term “target tool” as used herein refers generically to any tool which may accept an HDL model as input. Target tools may also include, for example, synthesis tools, timing tools, and power analysis tools.

Among the advantages of various embodiments of the present invention are one or more of the following.

One advantage of the system 200 shown in FIG. 2 is that it enables a single tool-independent circuit model to be used to generated a plurality of tool-specific circuit models, each of which is targeted at a particular target tool. As described above, although it is sometimes desirable to use multiple target tools, particularly for testing large-scale circuit designs within an enterprise, hand-coding individual tool-specific circuit models is tedious, time-consuming, and error prone. Providing a system which may generate multiple tool-specific circuit models from a single tool-independent circuit model has the advantages of using multiple target tools (e.g., using target tools to test portions of the circuit design for which they are particularly well-suited) without the disadvantages of hand-coding multiple tool-specific circuit models. The system 200 achieves these advantages by placing responsibility for generating tool-specific models in the circuit model processor 212 and the circuit block class definitions 216, thereby relieving the circuit modeler 204 of this responsibility.

In addition, a single tool-independent circuit model may be used in conjunction both with testing tools (such as ATPG tools) and tools for testing equivalence, further reducing the need for the manual development of multiple circuit models. The system 200 may be used to generate multiple tool-specific circuit models 206a-c even when all of the target tools 208a-c employ the same HDL (such as Verilog), by allowing block models designed for each of the target tools 208a-c to be provided using the same HDL.

In particular, it may be easier, less expensive, and less time-consuming to code and maintain a single tool-independent circuit models than to do the same for multiple tool-specific circuit models. Any changes to the circuit design need only be reflected in a single tool-independent circuit model rather than in multiple tool-specific circuit models.

Furthermore, separating out tool-specific features of a block model into a block class definition isolates the tool-specific features in the class definition. As a result, if a particular target tool changes the way in which it handles a particular kind of block, the corresponding tool-specific model need only be changed in the block class definition, rather than in each portion of the circuit model in which the block appears. Similarly, support for a new target tool may be added to the system 200 by performing a one-time addition of tool-specific block models to the class definitions 216, without needing to modify any circuit models. Existing circuit models may targeted at the new target tool without modification.

Furthermore, providing circuit block class definitions 216 which provide an abstract interface to the behavior of circuit block classes allows the circuit modeler 204 to develop circuit models at a higher level of abstraction, without having to provide tool-specific block models in the circuit model. The class definitions 216 capture fundamental circuit behavior while hiding complex circuit behaviors behind abstract interfaces. This may lead to circuit models that are easier to generate, understand, and maintain.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

Elements and components described herein may be further divided into additional components or joined together to form fewer components for performing the same functions.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and nonvolatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. In a system including a plurality of circuit testing tools, a method comprising steps of:
(A) receiving a tool-independent circuit model of a circuit, the tool-independent circuit model comprising a tool-independent block model modeling a first block in the circuit by reference to a class definition that defines a plurality of tool-specific models of a class of blocks including the first block; and
(B) generating a tool-specific circuit model of the circuit based on the tool-independent circuit model, a tool identifier identifying a particular one of the tools, and the class definition, the tool-specific circuit model being suitable for use with the particular one of the tools.

2. The method of claim 1, wherein the method comprises a method executed by a computer, wherein the tool-independent circuit model comprises a data structure tangibly stored on a computer-readable medium, and wherein the tool-specific circuit model comprises a data structure tangibly stored on a computer-readable medium.

3. The method of claim 1, wherein the class definition comprises one of a plurality of class definitions, and wherein the class definition comprises:
a class identifier uniquely identifying the class definition among the plurality of class definitions; and
the plurality of tool-specific models of the block.

4. The method of claim 1, wherein the tool-independent circuit model further comprises:
a generic block model modeling a second block in the circuit, the generic block model being suitable for use with all of the testing tools.

5. The method of claim 1, wherein the tool-independent block model comprises:
a class reference referencing the class definition.

6. The method of claim 1, wherein the class definition further comprises at least one parameter definition defining at least one parameter whose value may vary among instances of the class defined by the class definition.

7. The method of claim 6, wherein the tool-independent block model further comprises at least one parameter value providing a value for the at least one parameter defined by the at least one parameter definition.

8. The method of claim 1, wherein the tool-independent circuit model comprises a description defined according to a hardware description language.

9. The method of claim 8, wherein the hardware description language comprises Verilog.

10. The method of claim 8, wherein the hardware description language comprises VHDL.

11. The method of claim 1, wherein the tool-specific circuit model comprises a description defined according to a hardware description language.

12. The method of claim 11, wherein the hardware description language comprises Verilog.

13. The method of claim 11, wherein the hardware description language comprises VHDL.

14. The method of claim 1, wherein the tool-independent and tool-specific models of the circuit comprise descriptions defined according to a hardware description language.

15. The method of claim 14, wherein the hardware description language comprises Verilog.

16. The method of claim 14, wherein the hardware description language comprises VHDL.

17. The method of claim 1, wherein the circuit comprises a plurality of blocks, wherein the tool-independent circuit model comprises a plurality of block models modeling the plurality of blocks, wherein the class definition comprises one of a plurality of class definitions, and wherein the step (B) comprises steps of:
(B)(1) initializing the tool-specific circuit model; and
(B)(2) for each block model B in the plurality of block models:
(a) determining whether block model B is a tool-independent block model;
(b) adding block model B to the tool-specific circuit model if it is determined that block model B is not a tool-independent block model; and
(c) adding to the tool-specific circuit model a tool-specific block model M defined by one of the plurality of class definitions if it is determined that block model B is a tool-independent block model.

18. The method of claim 17, wherein the step (B)(2)(c) comprises steps of:
(B)(2)(c)(i) selecting one of the plurality of class definitions that defines a class of which block model B is an instance, the selected class definition including a plurality of tool-specific models of the class; and
(B)(2)(c)(ii) selecting as the tool-specific block model M one of the plurality of tool-specific models corresponding to the particular one of the tools identified by the tool identifier.

19. In a system including a plurality of circuit testing tools, an apparatus comprising:
means for receiving a tool-independent circuit model of a circuit, the tool-independent circuit model comprising a tool-independent block model modeling a first block in the circuit by reference to a class definition that defines a plurality of tool-specific models of a class of blocks including the first block; and
means for generating a tool-specific circuit model of the circuit based on the tool-independent circuit model, a tool identifier identifying a particular one of the tools, and the class definition, the tool-specific circuit model being suitable for use with the particular one of the tools.

20. The apparatus of claim 19, wherein the class definition comprises one of a plurality of class definitions, and wherein the class definition comprises:
a class identifier uniquely identifying the class definition among the plurality of class definitions; and
the plurality of tool-specific models of the block.

21. The apparatus of claim 19, wherein the tool-independent circuit model further comprises:
a generic block model modeling a second block in the circuit, the generic block model being suitable for use with all of the testing tools.

22. The apparatus of claim 19, wherein the tool-independent block model comprises:
a class reference referencing the class definition.

23. The apparatus of claim 19, wherein the class definition further comprises at least one parameter definition defining at least one parameter whose value may vary among instances of the class defined by the class definition.

24. The apparatus of claim 23, wherein the tool-independent block model further comprises at least one parameter value providing a value for the at least one parameter defined by the at least one parameter definition.

25. The apparatus of claim 19, wherein the tool-independent circuit model comprises a description defined according to a hardware description language.

26. The apparatus of claim 25, wherein the hardware description language comprises Verilog.

27. The apparatus of claim 25, wherein the hardware description language comprises VHDL.

28. The apparatus of claim 19, wherein the tool-specific circuit model comprises a description defined according to a hardware description language.

29. The apparatus of claim 28, wherein the hardware description language comprises Verilog.

30. The apparatus of claim 28, wherein the hardware description language comprises VHDL.

31. The apparatus of claim 19, wherein the tool-independent and tool-specific models of the circuit comprise descriptions defined according to a hardware description language.

32. The apparatus of claim 31, wherein the hardware description language comprises Verilog.

33. The apparatus of claim 31, wherein the hardware description language comprises VHDL.

34. The apparatus of claim 19, wherein the circuit comprises a plurality of blocks, wherein the tool-independent circuit model comprises a plurality of block models modeling the plurality of blocks, wherein the class definition comprises one of a plurality of class definitions, and wherein the means for generating the tool-specific circuit model comprises:
means for initializing the tool-specific circuit model; and
for each block model B in the plurality of block models:
means for determining whether block model B is a tool-independent block model;
first adding means for adding block model B to the tool-specific circuit model if it is determined that block model B is not a tool-independent block model; and
second adding means for adding to the tool-specific circuit model a tool-specific block model M defined by one of the plurality of class definitions if it is determined that block model B is a tool-independent block model.

35. The apparatus of claim 34, wherein the second adding means comprises:
means for selecting one of the plurality of class definitions that defines a class of which block model B is an instance, the selected class definition including a plurality of tool-specific models of the class; and
means for selecting as the tool-specific block model M one of the plurality of tool-specific models corresponding to the particular one of the tools identified by the tool identifier.
